(19) United States
(12) Patent Application Publication
(10) Pub. No.: US 2016/0102997 A1
(43) Pub. Date: Apr. 14, 2016

(54) Magnet Assembly for Vehicle Pedal Assembly and Other Rotary Position Sensors

(71) Applicants: Michael L. Wurn, Osceola, IN (US); Murray Kaijala, Elkhart, IN (US); William W. Wheeler, Middlebury, IN (US)

(72) Inventors: Michael L. Wurn, Osceola, IN (US); Murray Kaijala, Elkhart, IN (US); William W. Wheeler, Middlebury, IN (US)

(21) Appl. No.: 14/873,770

(22) Filed: Oct. 2, 2015

Related U.S. Application Data
(60) Provisional application No. 62/061,825, filed on Oct. 9, 2014.

(51) Int. Cl. G01D 5/14; H01F 7/02; B60T 7/04

(52) U.S. Cl. CPC G01D 5/145; B60T 7/042; H01F 7/021

(57) ABSTRACT

A magnet assembly retained on the rotor of a rotary position sensor such as, for example, the drum of a vehicle pedal. The drum of the vehicle pedal includes a retention pocket for the magnet assembly. In one embodiment, the magnet assembly includes a magnet with a pair of spaced apart legs and a pair of pole pieces abutted against the exterior of the legs. Each of the pole pieces includes a plurality of pointed barbs that are pressed into the material of the retention pocket on the drum of the vehicle pedal to retain the magnet assembly on the vehicle pedal.

### CROSS-REFERENCE TO RELATED AND CO-PENDING APPLICATIONS

This application claims the benefit of the filing date and disclosure of U.S. Provisional Patent Application Ser. No. 62/061,825 filed on Oct. 9, 2014 which is incorporated herein by reference as are all references cited therein.

### FIELD OF THE INVENTION

This invention pertains generally to a magnet assembly for a vehicle pedal assembly and other types of rotary position sensors and, more specifically, to a magnet assembly for a non-contacting rotary position sensor type vehicle accelerator pedal assembly.

### DESCRIPTION OF THE RELATED ART

The present invention is directed to the magnet assembly of a rotary sensor assembly such as for example a vehicle accelerator pedal assembly of the type disclosed in for example U.S. Pat. No. 7,404,342 to Wurn that comprises a non-contacting pedal position sensing assembly including a magnet assembly that is attached to the front of the drum of the pedal and a sensor such as a hall effect sensor that is adapted to sense changes in the magnetic flux generated by the magnet assembly in response to rotation of the pedal so as to allow measurement of the position of the pedal.

The present invention is directed to a new lower cost magnet assembly for such a vehicle accelerator pedal assembly or other type of rotary position sensor assembly.

### SUMMARY OF THE INVENTION

The present invention is generally directed to a magnet assembly adapted for retention on the rotor of a rotary position sensor assembly, the magnet assembly comprising a magnet and a pair of metal pole pieces attached to magnet and each defining at least a first barb adapted to be pressed into the material of the rotor to retain the magnet assembly on the rotor of the rotary position sensor assembly.

In one embodiment, the rotor includes a clip, the magnet assembly being retained in the clip and the at least first barb on the pair of pole pieces pressing into the material of the clip to retain the magnet assembly on the rotor.

In one embodiment, the magnet is generally U-shaped and includes a pair of spaced apart legs, the pair of metal pole pieces being attached to the exterior surface of the pair of legs respectively of the magnet.

In one embodiment, the rotor of the rotary position sensor assembly is the drum of a vehicle pedal.

The present invention is also directed to a vehicle pedal assembly comprising a pedal including a distal drum defining a pocket, and a magnet assembly retained on the drum of the pedal, the magnet assembly including a pair of spaced apart legs and a pair of metal pole pieces abutted against the exterior surface of the pair of legs of the magnet respectively, each of the pair of pole pieces including a pair of spaced apart and angled side edges defining first and second pairs of barbs that are pressed into the material of the pocket in the drum for retaining the pole pieces and the magnet assembly on the drum of the pedal.

In one embodiment, the second pair of barbs are shorter than the first pair of barbs.

The present invention is further directed to an assembly for retention of a magnet on a rotor of a non-contacting sensor assembly that is made of a plastic material and comprising at least a first barb on the magnet that is pressed into the plastic material of the rotor for retention of the magnet on the rotor.

In one embodiment, the rotor is the drum of a vehicle pedal.

In one embodiment, the magnet includes at least a first pole piece, the at least first barb being formed on the at least first pole piece.

In one embodiment, the drum of the vehicle pedal defines a pocket, the magnet including a base extending into the pocket of the drum, a pair of spaced apart magnet sections protruding unitarily from the base, and a pair of metal pole pieces abutted against an exterior surface of the respective magnet sections, the at least first barb being defined on each of the pair of magnet pole pieces and pressed into the plastic material of the pocket in the drum for retention of the magnet in the drum of the pedal.

In one embodiment, each of the pair of spaced apart magnet sections includes opposed diverging ribs, each of the magnet pole pieces including opposed diverging side edges abutted against the respective opposed diverging ribs of the respective pair of spaced apart magnet sections.

In one embodiment, each of the pair of pole pieces includes at least a first tab extending into at least a first notch defined in the base of the magnet.

In one embodiment, the drum of the pedal defines a pocket and the magnet includes a base fitted into the pocket of the drum, one of the pocket or the base defining at least a first slot and the other of the pocket or the base including at least a first rib fitted in the at least a first slot for retaining the base of the magnet in the pocket of the drum.

There are other advantages and features of this invention which will be more readily apparent from the following detailed description of the embodiment of the invention, the drawings, and the appended claims.

### BRIEF DESCRIPTION OF THE DRAWINGS

In the accompanying drawings that form part of the specification, and in which like numerals are employed to designate like parts throughout the same:

FIG. 1 is a perspective view of a vehicle accelerator pedal assembly;

FIG. 2 is a broken vertical cross-sectional view of the vehicle accelerator pedal assembly shown in FIG. 1;

FIG. 3 is a broken side elevational view of the magnet assembly of the present invention attached to the drum of the vehicle pedal assembly shown in FIG. 1;

FIG. 4 is a broken exploded perspective view of the pedal of the vehicle accelerator pedal assembly; and

FIG. 5 is another broken exploded perspective view of the pedal of the vehicle accelerator pedal assembly.

### DETAILED DESCRIPTION OF THE EMBODIMENT

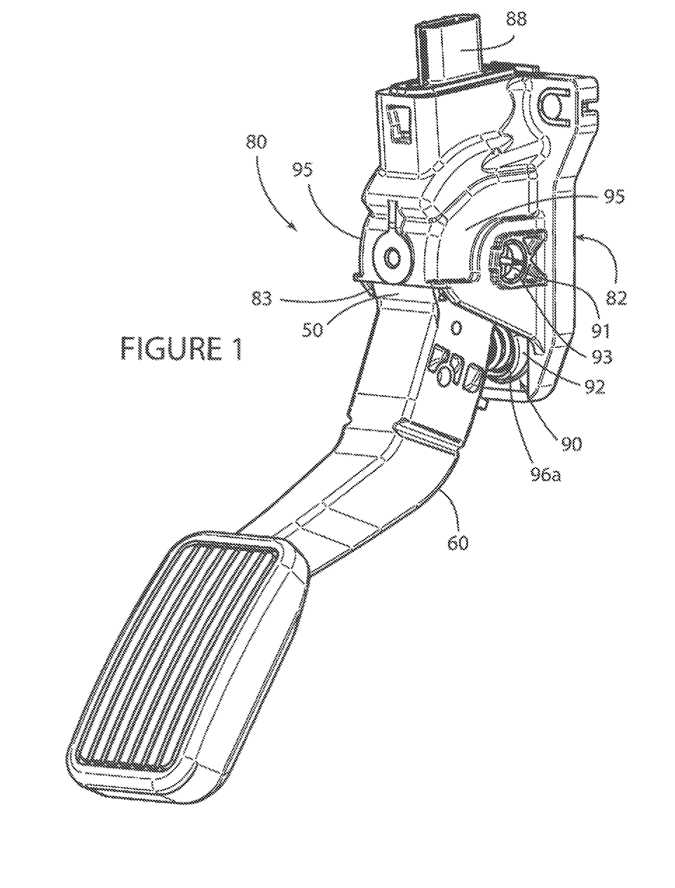

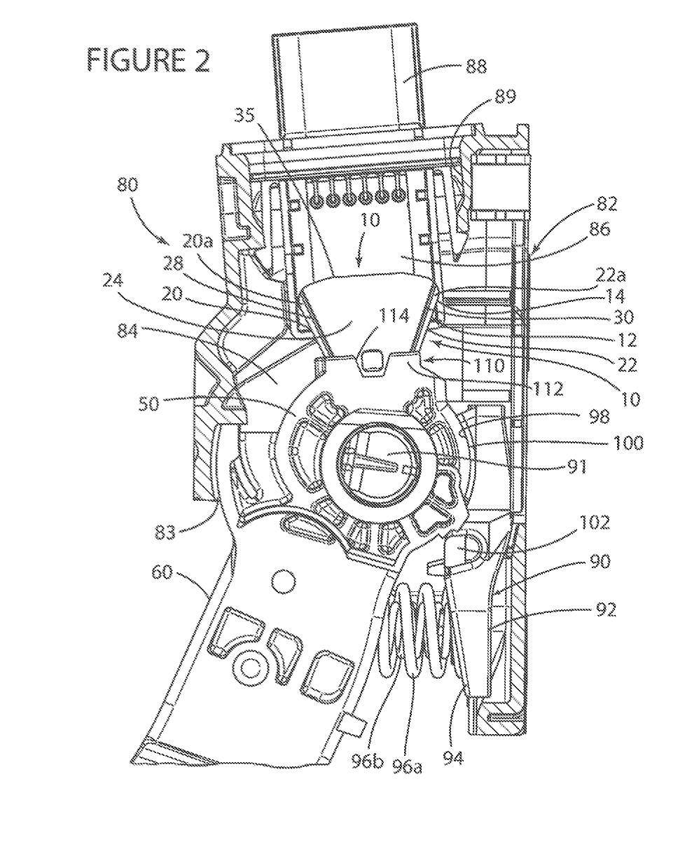

FIGS. 1 and 2 depict a vehicle accelerator pedal assembly or module 80 including a magnet assembly 10 (FIGS. 2-5) in accordance with the present invention which, in the embodiment shown, is attached to the front of a drum or rotor 50 of a pedal 60 of the vehicle accelerator pedal assembly or module 80 of a non-contacting rotary position sensor type as shown and further described in for example U.S. Pat. No. 7,404,342 to Wurn, the disclosure and contents of which are expressly incorporated herein by reference.

More specifically, and referring to FIGS. 1 and 2, the vehicle accelerator pedal assembly or module 80 includes a pedal housing 82 made of a molded thermoplastic material and defining a lower or front housing opening 83 in communication with an interior housing cavity 84 (FIG. 2) both of which are adapted to receive the generally cylindrically shaped drum 50 of the elongate pedal 60 that is also made of a molded thermoplastic material. The housing 82 and, more specifically, the interior housing cavity 84 thereof, is also adapted to receive and house a non-contacting rotary position sensor assembly comprising the combination of the magnet assembly 10 extending from the front of the drum 50 of the pedal 60 and a Hall Effect sensor (not shown in the FIGURES but shown in U.S. Pat. No. 7,404,342) mounted on a printed circuit board 86 (FIG. 2) also located in the interior housing cavity 84 and coupled to an electrical connector 88 that extends from the interior housing cavity 84 through an upper or rear housing opening 89 (FIG. 2) and outwardly from the exterior of the top of the pedal housing 82.

A stationary shaft 91 extends through the interior of the drum 50 and includes opposed ends extending into and fixed in opposed recesses 93 (only one of which is shown in FIG. 1) defined in opposed and spaced apart side walls 95 of the pedal housing 82 for mounting the pedal 60, and more specifically, the drum 50 of the pedal 60 for rotation in the interior housing cavity 84 relative to the pedal housing 82 and the shaft 91.

The vehicle accelerator pedal assembly or module 80 further comprises a pedal hysteresis or friction assembly 90 including a friction lever or pad 92 with a first distal end defining a receptacle 94 for the respective first ends of a pair of telescoping helical springs 96a and 96b and a second distal end that is diametrically opposed to the first distal end and defines a curved and concave friction surface 98 adapted for frictional contact and engagement with a complimentarily shaped curved and convex friction surface 100 on the drum 50 of the pedal 60. The friction lever 92 further includes and defines a pair of co-linear, spaced-apart, and diametrically opposed trunnions or pins 102 (only one of which is shown in the FIGURES but both of which are shown in one embodiment in U.S. Pat. No. 7,404,342) projecting unitarily outwardly from opposed sides of the lever or pad 92 and adapted to be received in respective opposed and spaced apart cheeks or recesses (not shown in the FIGURES but one embodiment of which are shown in U.S. Pat. No. 7,404,342) defined in the housing 82. The pair of pins 102 are generally centrally located on the lever 92 between the opposed distal ends of the lever 92 and define a teeter totter type pivot axis for the lever 92 that extends in a direction normal to the longitudinal axis of the lever 92.

The telescoping helical springs 96a and 96b are located and extend between the underside of the pedal 60 and the friction lever 92 and, more specifically, include respective second ends abutted against the underside of the pedal 60 and the opposed respective first ends abutted against and extending into the receptacle 94 on the friction lever 92.

In the embodiment shown, the helical springs 96a and 96b are located outside of the pedal housing 82 and the friction lever 92 is situated between the pedal 60 and the base of the pedal housing 82 in a relationship with the first distal end defining the receptacle 94 located outside of the pedal housing 82 and the second distal end defining the friction surface 98 located in the interior cavity 84 of the pedal housing 82.

In accordance with the operation of the vehicle assembly pedal assembly or module 80, depression of the pedal 60 by the foot of a user of a vehicle from its idle position in FIG. 1 results in the compression of the helical springs 96a and 96b which causes the distal end of the springs 96a and 96b received in the receptacle 94 of the friction lever 92 to exert a force against the first distal end of the friction lever 92 which in turn causes the pivoting or teeter totter type movement of the friction lever 92 relative to the housing 82 and about the pivot pins 102 on the lever 92 which then in turn causes the friction surface 98 on the opposed distal end of the friction lever 92 to exert an increased frictional pedal hysteresis force against the surface of the drum 50 of the pedal 60.

Depression of the pedal 60 also results in the rotational counter-clockwise movement of the drum 50 in the interior of the housing cavity 84 relative to the opposed side walls 95 of the pedal housing 82 which in turn causes the rotational counter-clockwise movement of the magnet assembly 10 extending from the exterior front surface of the drum 50 which in turn results in a change in the magnitude and direction of the magnetic flux generated by the magnet assembly 10 which is sensed by the Hall Effect sensor (not shown in the FIGURES but shown in U.S. Pat. No. 7,404,342) mounted on the printed circuit board 86 and converted into a signal for determining the rotary position of the drum 50 and the pedal 60.

Removal of a users foot from the pedal 60 causes the expansion of the helical springs 96a and 96b which results in the pivoting and clockwise movement of the friction lever 92 which in turn results in a reduction of the hysteresis force which the friction lever 92 applies to the drum 50 of the pedal 60 and results in the return of the pedal 60 to its idle position as shown in FIG. 1.

Referring to FIGS. 2 through 5 and FIGS. 4 and 5 in particular, the magnet assembly 10 of the present invention comprises a single unitary and generally U-shaped magnet 12 which, in the embodiment shown, includes a pair of spaced-apart, opposed, and generally parallel fan-shaped magnet portions or sections 14 and 16 that are unitary with, and project generally normally outwardly from, the respective opposed transverse distal edges of a central generally rectangular shaped base or trunk magnet portion or section 18 of the magnet 12.

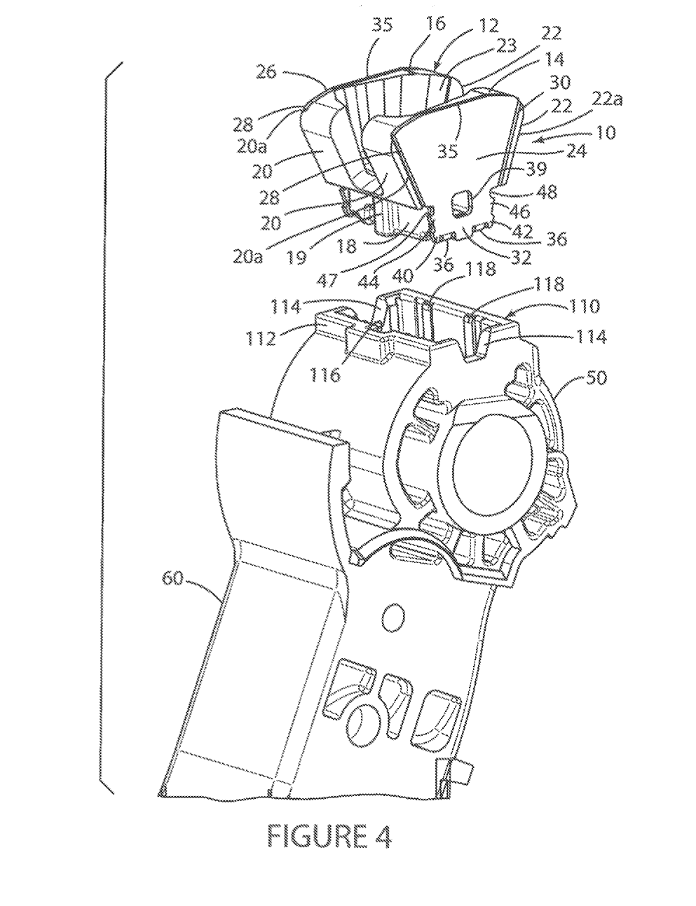

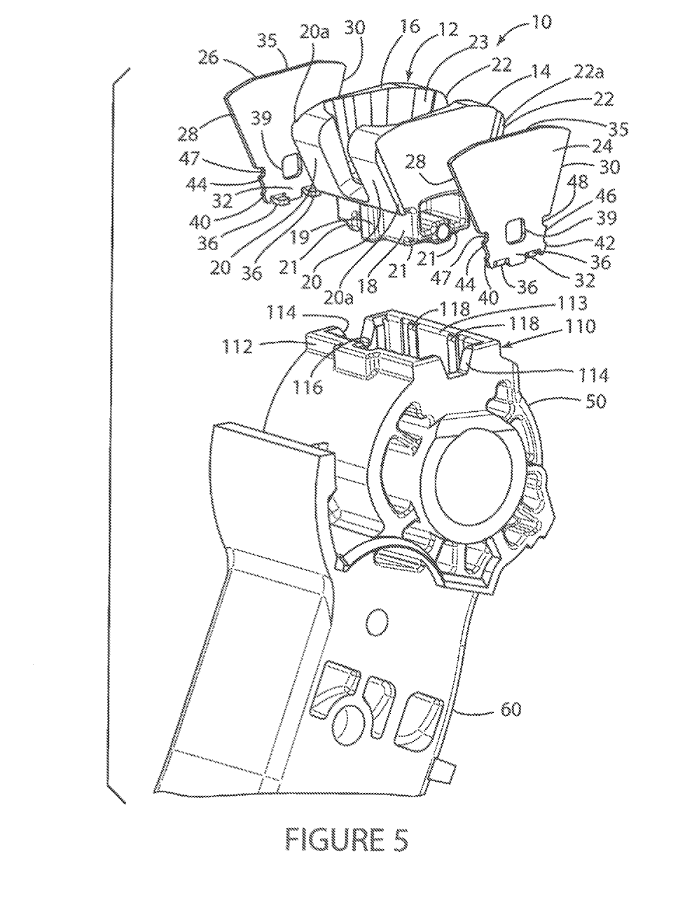

A vertical rib 19 (FIGS. 4 and 5) protrudes and projects outwardly from the exterior surface of one of the two opposed longitudinal side walls of the trunk portion 18 of the magnet 12. In the embodiment shown, the rib 19 is centrally located on the one of the opposed longitudinal side walls of the trunk portion 18 of the magnet 12 and extends in a vertical direction generally normal to the direction of the longitudinal axis of the trunk 18 of the magnet 12.

The trunk 18 of the magnet 12 additionally defines a plurality of lower or bottom inwardly extending notches 21 (FIG. 5). A first pair of spaced apart and parallel notches 21 are defined on a first transverse lower or bottom side edge of the trunk 18 and a second pair of spaced apart and parallel notches 21 are defined on a second transverse lower or bottom side edge of the trunk 18 in a diametrically opposed relationship to the first pair of spaced apart notches 21. The notches 21 extend horizontally in a direction normal to the vertical ribs 19. The ribs 19 are located between and spaced from the notches 21.

The fan-shaped magnet sections 14 and 16 are positioned in a spaced-apart and parallel relationship relative to each other and extend upwardly from, and in a direction generally normal to, the longitudinal axis of the base or trunk portion 18 of the magnet 12. An air gap or open slot 23 (FIGS. 4 and 5) is defined in the magnet 12 between the two fan-shaped magnet sections 14 and 16 and is bounded by the interior surfaces of the respective magnet portions 14, 16, and 18.

The magnet 12 is coupled to the drum 60 of the pedal 60 in a relationship with the magnet 12 extending in the interior cavity 84 and the printed circuit board 86 extending into the air gap 23 of the magnet 12 and, still more specifically, in a relationship with the Hall Effect sensor (not shown in the FIGURES but shown in U.S. Pat. No. 7,404,342) located in the air gap 23.

Each of the fan-shaped magnet portions 14 and 16 includes a pair of opposed, elongate, and angled peripheral side edges 20 and 22 that diverge away from each other and include and define respective elongate ribs 20a and 22a that protrude outwardly from the exterior surface face of the respective peripheral side edges 20 and 22.

The magnet assembly 10 further comprises a pair of flat metal (for example steel) magnetic flux conductors or pole pieces 24 and 26 which are of the same general fan-shape and surface area as the fan-shaped magnet portions 14 and 16.

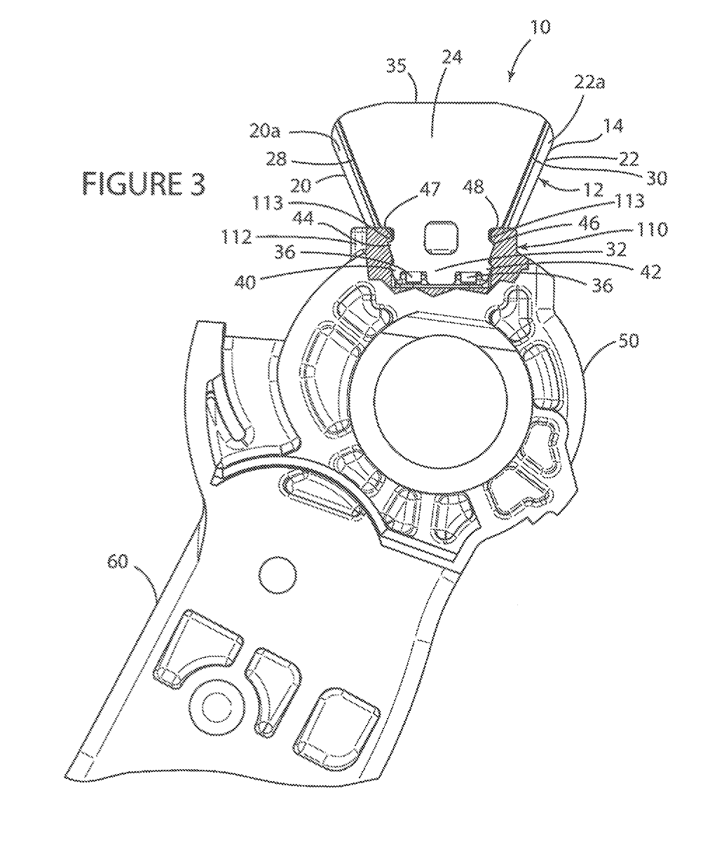

As more particularly shown in FIGS. 3, 4, and 5, each of the magnet pole pieces 24 and 26 is in the form of a generally fan-shaped flat metal plate that includes a pair of opposed, elongate, and angled side edges 28 and 30 that diverge away from each other; a central elongate base 32 therebetween defining a lower elongate horizontal edge that extends between the lower ends of the pair of angled and diverging side edges 28 and 30; and an upper elongate curved edge 35 that extends between the upper ends of the pair of angled and diverging side edges 28 and 30 of the respective pole pieces 24 and 26.

The lower edge of the base 32 of each of the magnet pole pieces 24 and 26 includes and defines a pair of spaced apart and parallel inwardly bent magnet retention tabs 36 that project and extend generally normally outwardly from the interior face of the lower edge of the base 32 of each of the magnet pole pieces 24 and 26.

Each of the magnet pole pieces 24 and 26, and more specifically, the plate thereof, additionally includes a generally square shaped through-hole or aperture 39 adapted to receive or cooperate with an appropriate tool (not shown) for placing and locating the magnet assembly 10 in the drum pocket 110 during the assembly process.

Each of the magnet pole pieces 24 and 26 additionally defines and includes a first pair of pointed barbs 40 and 42 defined and formed in the respective angled side edges 28 and 30 thereof; a second pair of pointed barbs 44 and 46 also defined in the respective angled side edges 28 and 30; and a pair of interior shoulders or recesses 47 and 48 also defined in the respective angled side edges 28 and 30.

The first pair of barbs 40 and 42; the second pair of barbs 44 and 46; and the pair of recesses 47 and 48 are respectively disposed on the respective angled side edges 28 and 30 of the respective pole pieces 24 and 26 in a diametrically opposed and co-linear relationship relative to each other with the points of the respective barbs 40, 42, 44, and 46 all pointing in the direction of the upper elongate curved edge 35 of the respective pole pieces 24 and 26. Additionally, and in the orientation of the magnet pole pieces 24 and 26 as shown in FIGS. 3, 4, and 5, the barb 40, the barb 44, and the shoulder 47 are positioned and extend along the length of the angled side edge 28 of each of the magnet pole pieces 24 and 26 in a relationship wherein the barb 40 is located and defined adjacent and spaced from the one end of the edge of the base 32 of each of the magnet pole pieces 24 and 26; the barb 44 is located and defined above and spaced from the barb 42; and the shoulder 47 is located and defined above and spaced from the barb 44.

In a similar manner, the barb 42, the barb 46, and the shoulder 48 are positioned and extend along the length of the opposed angled side edge 30 of each of the magnet pole pieces 24 and 26 in a relationship wherein the barb 42 is located and defined adjacent and spaced from the opposite end of the edge of the base 32 of each of the magnet pole pieces 24 and 26; the barb 46 is located and defined above and spaced from the barb 42; and the shoulder 48 is located and defined above and spaced from the barb 46.

Still further, in the embodiment shown in FIGS. 3, 4, and 5 the first pair of baits 40 and 42 are of a shorter length and distance from tip to tip than the second pair of barbs 44 and 46 and the second pair of barbs 44 and 46 are spaced and set in the plate inwardly from the respective first set of barbs 40 and 42.

Referring again to FIGS. 3, 4, and 5, the front of the drum 50 of the pedal 60 includes and defines a generally rectangular shaped open cavity or pocket or clip 110 that is defined by a circumferentially extending wall 112 and protrudes outwardly from the front exterior surface of the drum 50. A generally U-shaped notch 114 is defined in and extends through each of the opposed transverse sections of the wall 112; an elongate vertical slot 116 is defined in the interior surface of one of the opposed longitudinal sections of the wall 112; and a pair of elongate, spaced-apart, and parallel vertical crush ribs 118 (only one of the pairs of which is shown in FIGS. 4 and 5) protrude outwardly from the interior surface of each of the opposed longitudinal sections of the wall 112 in a relationship wherein the slot 116 is centrally located along the one of the opposed longitudinal sections of the wall 112 between and spaced from the ribs 118 defined on each of the opposed longitudinal sections of the wall 112. In the embodiment shown, the U-shaped notches 114 are positioned in a relationship co-linear with the longitudinal axis of the pocket 110 and the slot 116 and the ribs 118 extend on opposed sides and spaced from the longitudinal axis of the pocket 110 and further in direction normal to the direction of the longitudinal axis of the pocket 110. The wall 112 also includes an elongate interior lip 113 that projects unitarily outwardly from the interior surface of the upper longitudinal edge of each of the longitudinal sections of the wall 112.

In accordance with the present invention, and as part of the manufacturing and assembly process, the fan shaped magnet pole piece 24 is attached to the magnet 12 in a relationship wherein the inside exterior face of the plate of the fan shaped magnet pole piece 24 is abutted against the exterior face of the fan shaped magnet portion 14 of the magnet 12; the respective tabs 36 on the fan shaped magnet pole piece 24 are extended into the respective notches 21 defined in the one transverse side edge of the trunk 18 of the magnet 12; and the respective angled side edges 28 and 30 of the fan shaped magnet pole piece 24 are abutted against the interior edge of the respective ribs 20a and 22a of the fan shaped magnet portion 14 of the magnet 12 thereby locating and positioning the magnet pole piece 24 on the exterior face of the fan shaped portion 14 of the magnet 12.

In a like manner, the respective fan shaped magnet pole piece 26 is attached to the magnet 12 in a relationship wherein the inside exterior face of the plate of the fan shaped magnet pole piece 26 is abutted against the exterior face of the opposed fan shaped magnet portion 16 of the magnet 12; the respective tabs 36 on the fan shaped magnet pole piece 26 extend into the respective notches 21 defined in the opposed transverse side edge of the trunk 18 of the magnet 12; and the respective angled side edges 28 and 30 of the fan shaped magnet pole piece 26 are abutted against the interior edge of the respective ribs 20a and 22a of the fan shaped magnet portion 16 thereby locating and positioning the magnet pole piece 24 on the exterior face of the fan shaped portion 16 of the magnet 12 in a relationship diametrically opposed to the magnet pole piece 24.

Thereafter, in accordance with the present invention, and also as part of the manufacturing and assembly process, the magnet assembly 10 with the magnet pole pieces 24 and 26 attached thereto is then secured to the drum 50 of the pedal 60 in a relationship with the trunk 18 of the magnet 12 fitted and located in the pocket or clip 110 at the front of the drum 50 and, more specifically, in a relationship with the rib 19 on the trunk 18 of the magnet 12 fitted and located in the slot 116 defined on the interior face of the wall 112 defining the pocket 110; and the exterior peripheral wall of the trunk 18 of the magnet 12 in an interference fit relationship with the interior surface of the peripheral wall 112 defining the drum pocket 110; and, still more specifically, in a relationship wherein the ribs 118 on the interior surface of the respective opposed longitudinal wall sections of the drum pocket 110 have been crushed against the exterior surface of the opposed longitudinal wall sections of the trunk 18 of the magnet 12 for providing a secure interference fit of the magnet assembly 10 in the drum pocket 110.

The U-shaped notches 114 defined in the drum pocket 110 allow and provide for clearance for the tool (not shown) that is used during the assembly process to place and locate the magnet assembly 10 in the drum pocket 10.

Moreover, in accordance with the present invention and as shown in FIG. 3, the respective lips 113 on the interior upper edge of the opposed longitudinal sections of the pocket wall 112 extend into the respective grooves 47 and 48 defined in the respective edges 28 and 30 of the respective magnet pole pieces 24 and 26 and the pointed tips of the respective barbs 40, 42, 44, and 46 on the respective magnet pole pieces 24 and 26 protrude and penetrate into the thermoplastic material of the interior surface of the opposed longitudinal sections of the pocket wall 112 to wedge, retain, and lock the magnet pole pieces 24 and 26 and thus the magnet assembly 10 in the pocket 110 and the retain the magnet assembly 10 on the drum 50 of the pedal 60.

In accordance with the present invention, the use of magnet pole pieces 24 and 26 with the disclosed barbs 40, 42, 44, and 46 allows for a press interference fit and securement of the magnet assembly 10 to the pedal 60 and eliminates the current need for heat staking the magnet assembly to the drum 50 of the pedal 60 thus providing for an easier to assemble and lower cost magnet assembly 10 and pedal assembly 80. Moreover, the use of a first pair of barbs 40 and 42 on the respective magnet pole pieces 24 and 26 which are shorter than the second pair of barbs 44 and 46 allows the second pair of barbs 44 and 46 to have an equal or greater amount of press interference fit than the first pair of barbs 40 and 42 with the surface of the respective opposed longitudinal sections of the wall 112 of the pocket 110.

Numerous variations and modifications of the embodiment described above may be effected without departing from the spirit and scope of the novel features of the invention including for example the use of the magnet assembly of the present invention in connection with not only accelerator pedal assemblies but also other types of assemblies incorporating non-contacting rotary position sensor assemblies and in which the magnet assembly is retained on the rotor of such assembly.

It is to be further understood that no limitations with respect to the magnet assembly illustrated herein are intended or should be inferred. It is, of course, intended to cover by the appended claims all such modifications as fall within the scope of the claims.

What is claimed is:

1. A magnet assembly adapted for retention on the rotor of a rotary position sensor assembly, the magnet assembly comprising:
a magnet; and
a pair of metal pole pieces attached to the magnet and each defining at least a first barb adapted to be pressed into the material of the rotor to retain the magnet assembly on the rotor of the rotary position sensor assembly.

2. The magnet assembly of claim 1 wherein the rotor includes a clip, the magnet assembly being retained in the clip and the at least first barb on the pair of pole pieces pressing into the material of the clip to retain the magnet assembly on the rotor.

3. The magnet assembly of claim 2, wherein the magnet is generally U-shaped and includes a pair of spaced apart legs, the pair of metal pole pieces being attached to the exterior surface of the pair of legs respectively of the magnet.

4. The magnet assembly of claim 3, wherein the rotor of the rotary position sensor assembly is the drum of a vehicle pedal.

5. A vehicle pedal assembly comprising:
a pedal including a distal drum defining a pocket; and
a magnet assembly retained on the drum of the pedal, the magnet assembly including a pair of spaced apart legs and a pair of metal pole pieces abutted against the exterior surface of the pair of legs of the magnet respectively, each of the pair of pole pieces including a pair of spaced apart and angled side edges defining first and second pairs of barbs that are pressed into the material of the pocket in the drum for retaining the pole pieces and the magnet assembly on the drum of the pedal.

6. The vehicle pedal assembly of claim 5, wherein the second pair of barbs are shorter than the first pair of barbs.

7. An assembly for retention of a magnet on a rotor of a non-contacting sensor assembly that is made of a plastic materiel and comprising at least a first barb on the magnet that is pressed into the plastic material of the rotor for retention of the magnet on the rotor.

8. The assembly of claim 7, wherein the rotor is the drum of a vehicle pedal.

9. The assembly of claim 8, wherein the magnet includes at least a first pole piece, the at least first barb being formed on the at least first pole piece.

10. The assembly of claim 9, wherein the drum of the vehicle pedal defines a pocket, the magnet including a base extending into the pocket of the drum, a pair of spaced apart magnet sections protruding unitarily from the base, and a pair of metal pole pieces abutted against an exterior surface of the respective magnet sections, the at least first barb being defined on each of the pair of magnet pole pieces and pressed into the plastic material of the pocket in the drum for retention of the magnet in the drum of the pedal.

11. The assembly of claim 10, wherein each of the pair of spaced apart magnet sections includes opposed diverging ribs, each of the magnet pole pieces including opposed diverging side edges abutted against the respective opposed diverging ribs of the respective pair of spaced apart magnet sections.

12. The assembly of claim 10, wherein each of the pair of pole pieces includes at least a first tab extending into at least a first notch defined in the base of the magnet.

13. The assembly of claim 8, wherein the drum of the pedal defines a pocket and the magnet includes a base fitted into the pocket of the drum, one of the pocket or the base defining at least a first slot and the other of the pocket or the base including at least a first rib fitted in the at least a first slot for retaining the base of the magnet in the pocket of the drum.
